(19) United States
(12) Patent Application Publication
(10) Pub. No.: US 2007/0278283 A1
(43) Pub. Date: Dec. 6, 2007

(54) Paper Puncher

(76) Inventor: Tung-Long Chiang, Tou Liu City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/382,824

(22) Filed: Jun. 2, 2006

(51) Int. Cl. B26F 1/14

(52) U.S. Cl. 234/109; 83/691

(57) ABSTRACT

A paper puncher includes a driving shaft, an upper cutter, a lower cutter, a control panel and a paper limiter. Both the upper cuter and the lower cutter are linked to the driving shaft and both comprise a pin thereat. The control panel comprises a trough corresponding to the pins of the cutters. The control panel comprises a post, and the paper limiter comprises a guide slot corresponding to the post. The trough comprises a vertical slot and a horizontal slot interconnected with each other. By sliding the control panel, the vertical slot of the trough allows either the pin of the upper cutter or the pin of the lower cutter to slide therein, and the post of the control panel slides in the guide slot to confine the movement of the paper limiter.

### BACKGROUND OF THE INVENTION

1. Field of the Invention

The present invention relates to a paper puncher, and more particularly to a control panel linking a paper limiter and controlling a driving shaft to activate either an upper cutter or a lower cutter.

2. Description of the Prior Art

Some conventional paper punchers are formed with double troughs with corresponding double blades. However, up to date, there are no paper punchers using a single trough sharing with double blades.

The design of double troughs and double blades requires a relative larger size, takes up more space and is relatively more complicated, which is not cost-effective.

### SUMMARY OF THE INVENTION

It is the primary object of the present invention to provide a paper puncher, which controls double blades to punch holes separately, as desired.

It is another object of the present invention to provide a paper puncher, which is easy to operate.

It is a further object of the present invention to provide a paper puncher, which is relatively simple in structure and is relatively cost-effective.

According to the present invention, there is provided a paper puncher comprising a driving shaft, an upper cutter, a lower cutter and a control panel, said driving shaft being connected with a linking block, a first linking rod, an upper cutter linking rod and a lower cutter linking rod, said upper cutter being connected with an upper cutter seat, said lower cutter being connected with a lower cutter seat, said driving shaft being fixedly connected to said linking block, said linking block being pivotally connected to a first end of said first linking rod, a second end of said first linking rod being pivotally connected to a first end of said upper cutter linking rod and a first end of said lower cutter linking rod, a second end of said upper cutter linking rod being pivotally connected to said upper cutter seat, a second end of said lower cutter linking rod being pivotally connected to said lower cutter seat, said driving shaft linking said upper cutter seat and said lower cutter seat, each of said upper cutter seat and said lower cutter seat comprising a pin, said control panel comprising a trough corresponding to said pins of said upper cutter seat and said lower cutter seat, said control panel further comprising a post and said paper limiter comprising a guide slot corresponding to said post of said control panel, said trough of said control panel comprising a vertical slot and an interconnected horizontal slot, by sliding said control panel, said vertical slot of said trough allowing either said pin of said upper cutter seat or said pin of said lower cutter seat to slide therein, and said post of said control panel sliding in said guide slot to control movement of said paper limiter.

Preferably said trough of said control panel is shaped like an English letter T.

Preferably said trough of said control panel is shaped like an English letter U.

### BRIEF DESCRIPTION OF THE DRAWINGS

FIG. 1 is a side cross-sectional view of the present invention showing the operation of an upper cutter;

FIG. 2 is a top view of the present invention showing a control panel and a paper limiter when operating the upper cutter;

FIG. 3 is a side cross-sectional view of the present invention showing the operation of a lower cutter; and

FIG. 4 is a top view of the present invention showing the control panel and the paper limiter when operating the lower cutter.

### DETAILED DESCRIPTION OF THE PREFERRED EMBODIMENT

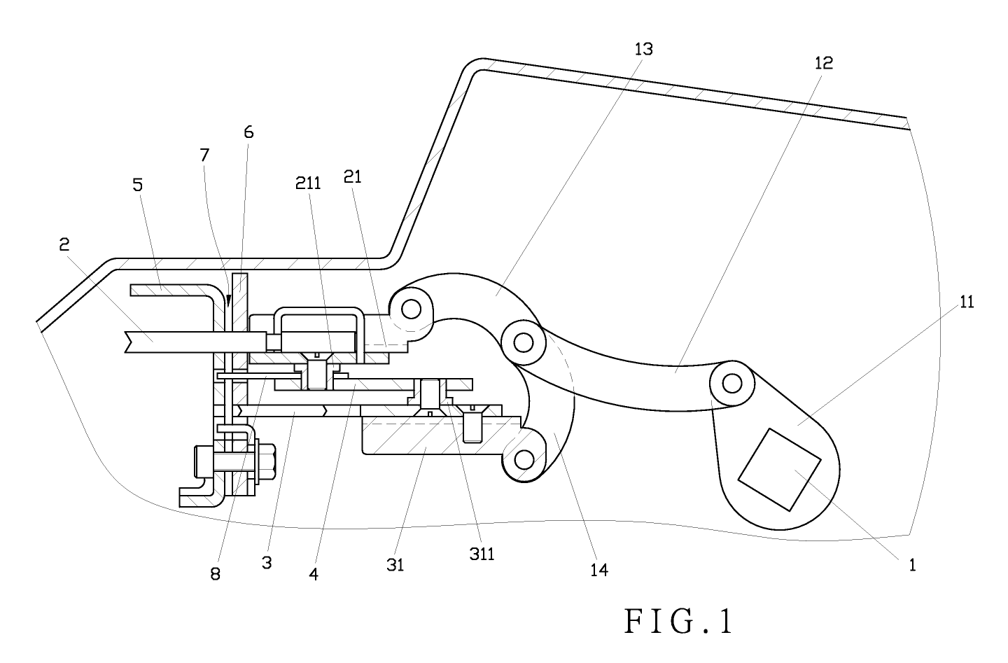

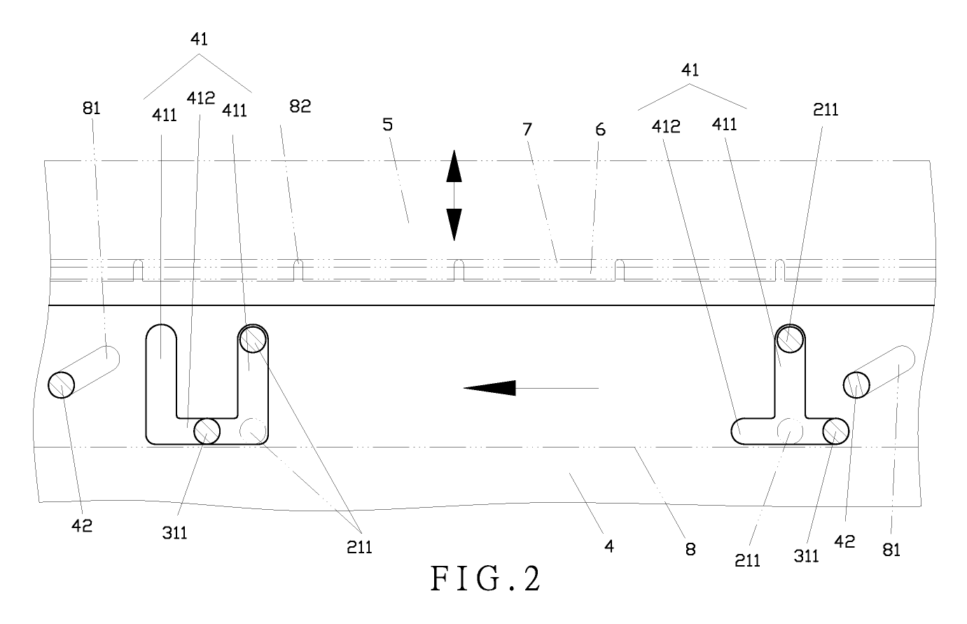

As shown in FIGS. 1 and 2, the present invention comprises a driving shaft 1, an upper cutter 2, a lower cutter 3, a control panel 4 and a paper limiter 8 along with a front guide 5, a rear guide 6 and a paper tray 7 formed between the guides 5 and 6.

The driving shaft 1 is connected with a linking block 11, a first linking rod 12, an upper cutter linking rod 13, and a lower cutter linking rod 14.

The upper cutter 2 is linked to an upper cutter seat 21. The upper cutter seat 21 is provided with a pin 211.

The lower cutter 3 is linked to a lower cutter seat 31. The lower cutter seat 3 1 is provided with a pin 311.

The control panel 4 comprises a trough 41 corresponding to the pin 211 of the upper cutter seat 21 and the pin 311 of the lower cutter seat 31, respectively. The control panel 4 is provided with a post 42. The trough 41 comprises a vertical slot 411 and a horizontal slot 412 interconnected with each other. The shape of the trough 41 may be in T-shaped, U-shaped or L-shaped design.

The paper limiter 8 comprises a guide slot 81 corresponding to the post 42 and a stopper 82 at a front end thereof.

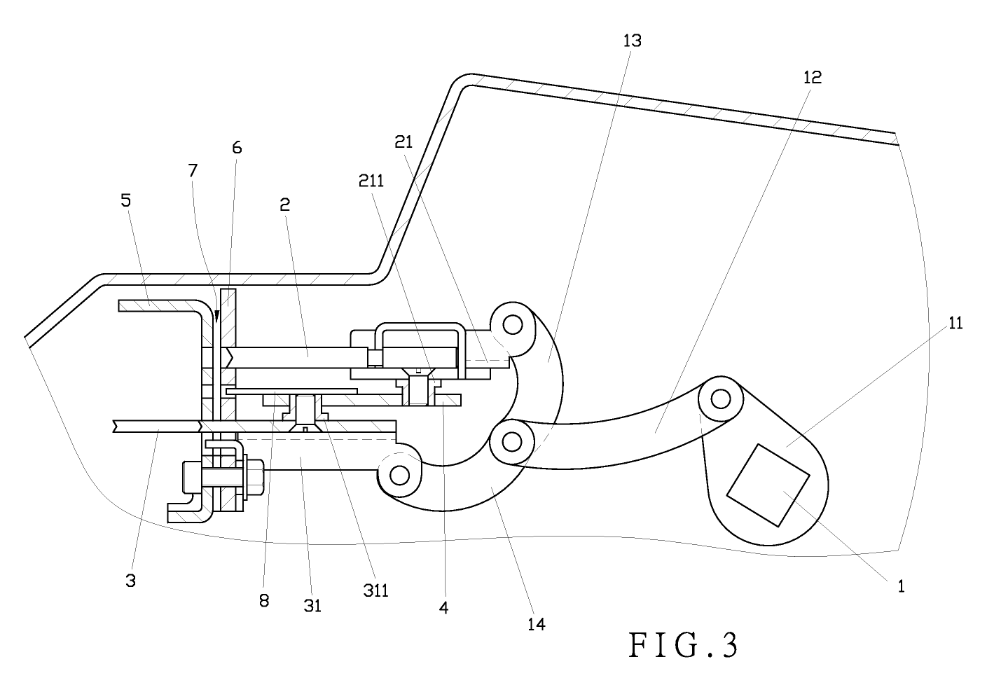

The linking block 11 is fixedly connected to the driving shaft 1, as shown in FIGS. 1 and 3. The linking block 11 is pivotally connected to a first end of the first linking rod 12. A second end of the first linking rod 12 is pivotally connected to a first end of the upper cutter linking rod 13 and a first end of the lower cutter linking rod 14, respectively. A second end of the upper cutter linking rod 13 is pivotally connected to the upper cutter seat 21, while a second end of the lower cutter linking rod 14 is pivotally connected to the lower cutter seat 31. Thus the driving shaft 1 controls the upper cutter seat 21 and the lower cutter seat 31 which are fixedly connected with the upper cutter 2 and the lower cutter 31, respectively. The cutters 2 and 3 extend in the front guide 5, the rear guide 6 and the paper tray 7 formed between the front guide 5 and the rear guide 6.

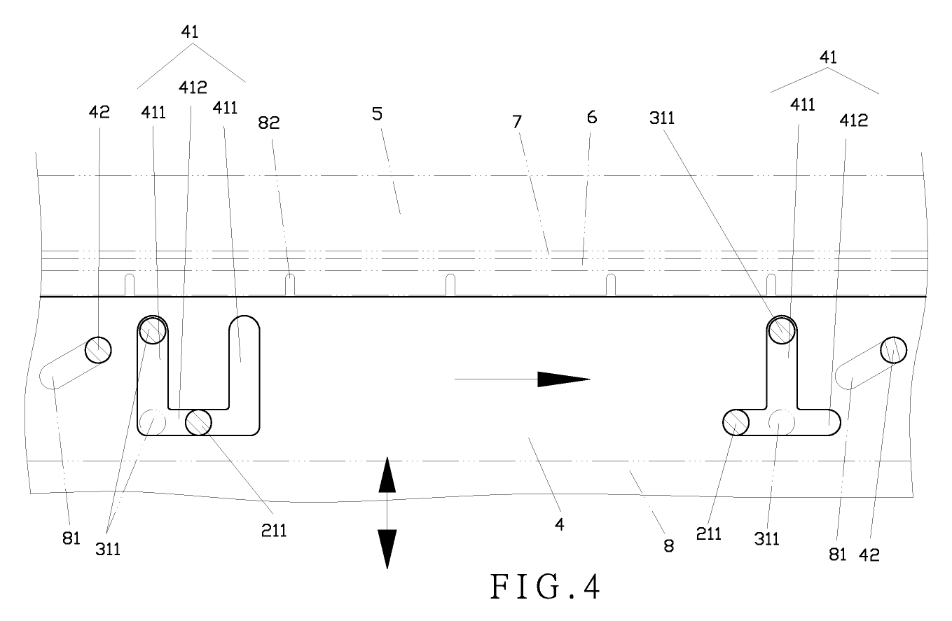

By sliding the control panel 4, as shown in FIGS. 2 and 4, the vertical slot 411 of the trough 41 corresponds to either the pin 211 of the upper cutter seat 21 or the pin 311 of the lower cutter seat 31. The post 42 of the control panel 4 slides in the guide slot 81 to link the paper limiter 8 to slide and the stopper 82 to protrude into the paper tray 7 to stop paper loading so that the upper cutter 2 is activated. Alternatively, when the stopper 82 retreats from the paper tray 7, the lower cutter 3 is activated.

To operate the present invention, as shown in FIGS. 1 and 2, the control panel 4 pulls the paper limiter 8 outwardly when the upper cutter 2 is activated. The stopper 82 of the paper limiter 8 extends into the paper tray 7 to stop paper. The pin 311 of the lower cutter seat 31 is confined in the horizontal slot 412 of the trough 41, thus only the pin 211 of the upper cutter seat 21 is able to slide in the vertical slot 411 of the trough 41. Therefore, when the linking block 11 of the driving shaft 1 activates the first linking rod 12 which then links the upper cutter linking rod 13, and the pin 311 of the lower cutter seat 31 is blocked from moving, only the upper cutter 2 is activated to punch the paper.

When the lower cutter 3 is activated, the control panel 4 will push and link the paper limiter 8. The stopper 82 of the paper limiter 8 at this moment will retreat back from the paper tray 7, and the pin 211 of the upper cutter seat 21 will be confined in the horizontal slot 412 of the trough 41, only the pin 311 of the lower cutter seat 31 is able to slide along the vertical slot 411 of the trough 41. Thus, when the linking block 11 of the driving shaft 1 activates the first linking rod 12, in return, it can only activate the lower cutter linking rod 14 to punch holes on the paper.

What is claimed is:

1. A paper puncher comprising a driving shaft, an upper cutter, a lower cutter and a control panel, said driving shaft being connected with a linking block, a first linking rod, an upper cutter linking rod and a lower cutter linking rod, said upper cutter being connected with an upper cutter seat, said lower cutter being connected with a lower cutter seat, said driving shaft being fixedly connected to said linking block, said linking block being pivotally connected to a first end of said first linking rod, a second end of said first linking rod being pivotally connected to a first end of said upper cutter linking rod and a first end of said lower cutter linking rod, a second end of said upper cutter linking rod being pivotally connected to said upper cutter seat, a second end of said lower cutter linking rod being pivotally connected to said lower cutter seat, said driving shaft linking said upper cutter seat and said lower cutter seat, each of said upper cutter seat and said lower cutter seat comprising a pin, said control panel comprising a trough corresponding to said pins of said upper cutter seat and said lower cutter seat, said control panel further comprising a post and said paper limiter comprising a guide slot corresponding to said post of said control panel, said trough of said control panel comprising a vertical slot and an interconnected horizontal slot, by sliding said control panel, said vertical slot of said trough allowing either said pin of said upper cutter seat or said pin of said lower cutter seat to slide therein, and said post of said control panel sliding in said guide slot to control movement of said paper limiter.

2. The paper puncher, as recited in claim 1, wherein said paper limiter comprises a stopper at a front end thereof.

3. The paper puncher, as recited in claim 1, wherein said trough of said control panel is shaped like an English letter T.

4. The paper puncher, as recited in claim 1, wherein said trough of said control panel is shaped like an English letter U.
